(19) United States
(12) Patent Application Publication
(10) Pub. No.: US 2008/0279587 A1
(43) Pub. Date: Nov. 13, 2008

(54) DIGITAL MULTI-COLOR PRINTING MACHINE

(76) Inventors: Soenke Dehn, Daenischenhagen (DE); Uwe Fischer, Rostock (DE); James D. Shifley, Spencerport, NY (US)

Correspondence Address: David A. Novais;Patent Legal Staff, Eastman Kodak Company, 343 State Street, Rochester, NY, 14650-2201, US

(21) Appl. No.: 11/746,179

(22) Filed: May 9, 2007

(51) Int. Cl. G03G 15/16

(52) U.S. Cl. 399/121

(57) ABSTRACT

A printing unit for a digital multi-color printing machine, in particular for an electrophotographically operating, preferably sheet-printing printing machine, said printing unit comprising at least one transfer element (11), preferably an imaging cylinder (31) and/or a cylinder bearing a rubber blanket, for the transfer of a printing image. The invention provides a multi-color printing machine which also allows the production of high-quality prints with fewer colors, i.e., in a more cost-effective manner than if a multi-color print were produced with the same printing machine. In accordance with the invention, this object is achieved by a printing unit for a digital multi-color printing machine, which is characterized in that the transfer element (11) is moved from a transfer position into an inoperative position.

### FIELD OF THE INVENTION

The invention relates to a printing unit for a digital multi-color printing machine, in particular for an electrophotographically operating, sheet-printing printing machine comprising at least one transfer element, preferably an imaging cylinder and/or a cylinder bearing a rubber blanket, for the transfer of a printing image.

### BACKGROUND OF THE INVENTION

In the field of digital printing machines, there are, in particular, multi-color printing machines having usually four or five printing units which produce high-quality, but also relatively expensive, color prints and, for this purpose, use the standard colors cyan, magenta, yellow and black and/or custom colors and, optionally, glossy coatings. On the other hand, there are black-and-white printing machines, which are more cost-effective and produce single-color prints that are also simpler from a quality perspective. Sometimes, there are also two-color printing machines or downstream simplex printing machines which, for example, add a custom color print to a single-color print.

However, the market increasingly demands digital multi-color printing machines which are capable of producing high-quality color prints, preferably, with a high-gloss finish. In most cases, such printing machines are used at a high percentage of their capacity, but not at one hundred percent. Therefore, it would be desirable to increase the utilization of such printing machines.

Other attempts to solve this problem have met with limited success. Generally, it is known to run an electrophotographic printer in different modes, in which a different number of printing units are known, specifically a black-and-white mode and a color mode as described in U.S. Pat. No. 6,108,017. The controller transmits the black image data faster in the monochrome printing mode than in the color printing mode. U.S. Patent Application Publication No. 2003/0202199 describes a color printer having a black and white lock mode. Access to the color mode needs an access code. This approach saves toner only for single path printers as the other printing units are still in contact. On the other hand it is known from other areas of the printing technology to engage or disengage print cylinders as described in U.S. Pat. No. 5,167,187, where a throw-on and throw-off device for a blanket cylinder is mounted at both ends in eccentric bushings and their pivoting throw-on/throw-off movement is produced by a toggle-like linkage. Another solution is described in U.S. Pat. No. 4,833,982 wherein a crank arrangement is used to disengage at least one of the printing cylinders. U.S. Pat. No. 4,526,099 describes a reversible color deck apparatus for rotary printing presses. The axes of rotation of the blanket rolls can be moved in two different positions allowing printing the specific color on one or the other side of the paper web.

Therefore, the object of the invention is to provide a digital multi-color printing machine which also allows the production of high-quality prints with fewer colors, in a more cost-effective manner than if a multi-color print were produced with the same printing machine.

### SUMMARY OF THE INVENTION

In accordance with the invention, this object is achieved by a printing unit for a digital multi-color printing machine, which is characterized in that the transfer element can be moved from a transfer position into an inoperative position.

Therefore, in this manner, advantageously a multi-color printing machine can be optionally operated with fewer, i.e. less than all printing units. This has the result that, due to the none-use of individual printing units, the cost per print can be lowered, and the printing machine continues printing with its customary printing quality, optionally, for example, with a high gloss. The high gloss may be achieved by means of a special printing treatment, for example, by means of electrophotographic fusion, or by providing a coating in the last printing unit. As a result of this, it is possible to completely avoid the additional investment in a single-color printing machine.

An embodiment of the invention provides that the transfer element that can be moved into the two different positions is a rubber blanket cylinder. Such a rubber blanket cylinder, which is typical of offset printing machines, but is also often used in digital printing machines, in particular in electrophotographic printing machines, offers the advantage that the printing quality is less dependent on the quality of the printing material, i.e., high printing quality can be achieved across a particularly large spectrum of different qualities of printing materials.

In accordance with the invention, such a rubber blanket cylinder can be brought into an inoperative position in a particularly simple manner when the rubber blanket cylinder, without being directly driven itself, can be indirectly made to rotate when in contact with an imaging cylinder and/or a printing material transport belt. The transfer element which can be brought into two positions can preferably be moved out of a printing material path of the printing machine or it can be moved away from a printing material along the transport belt that transports the printing material along the printing material path. Such a transfer element can be viewed as being inoperative, for example, in particular when it is at a distance of, for example, approximately 10 millimeters from the printing material.

The present invention can be used, in particular, in a printing unit which possesses an imaging web for collecting and imaging color separations, said web, for example, being used in place of the imaging cylinders of an electrophotographic printing machine, or which possesses a transfer web for collecting color separations that have already been imaged on imaging cylinders, before said color separations are transferred to a printing material, i.e., said latter web being used in place of rubber blanket cylinders, and thus there is at least one transfer element which guides and carries along such an aforementioned transfer web. By changing the position of the transfer element in accordance with the invention, the effect of the transfer web on the printing material can be prevented. In other words, for example, the rubber blanket of a rubber blanket cylinder need not completely envelop 360 degrees, but said blanket may only partially envelop said rubber blanket cylinder, in which case a printing nip, which can be varied in accordance with the invention in this enveloping region could be formed.

The inventive position change of a transfer element could be achieved in different ways by mechanical means. For example, the transfer element could be pivoted in and out by means of an eccentric arrangement. Another option could be that the transfer element can be moved by means of a lever system. For example, the transfer element could also be moved by means of a sliding guide. Another option could be that the transfer element could potentially be moved along a guide path. In particular, the transfer element could potentially be moved in a direction transverse to its axial direction; however, it could potentially also be moved out into axial direction.

### BRIEF DESCRIPTION OF THE DRAWINGS

FIG. 1 is a schematic illustration of a first embodiment of a transfer element having a variable position in accordance with the present invention.

FIG. 2 is a schematic illustration of a second embodiment of a transfer element having a variable position in accordance with the present invention.

FIG. 3 is a schematic illustration of a third embodiment of a transfer element having a variable position in accordance with the present invention.

FIG. 4 is a schematic illustration of a fourth embodiment of a transfer element having a variable position in accordance with the present invention.

FIG. 5 is a detailed perspective illustration of a fourth embodiment using a transfer element having a variable position in accordance with the invention shown in FIG. 4.

FIG. 6 is a sectional view of a fifth embodiment of a transfer element having a variable position in accordance with the present invention.

FIG. 7 is a detailed perspective illustration of another embodiment of a transfer element having a variable position in accordance with the present invention.

FIG. 8 shows the front side of the transfer element of FIG. 7.

### DETAILED DESCRIPTION OF THE INVENTION

FIG. 1 shows a schematic illustration of a first embodiment of a transfer element having a position that is variable in accordance with the invention. In this embodiment, the transfer element 11 is guided in a sliding guide 12 or a carriage guide and thus is arranged in a sliding manner. An imaging cylinder 31 where the image may be generated and a transport belt 30 to which the image can be transferred is shown.

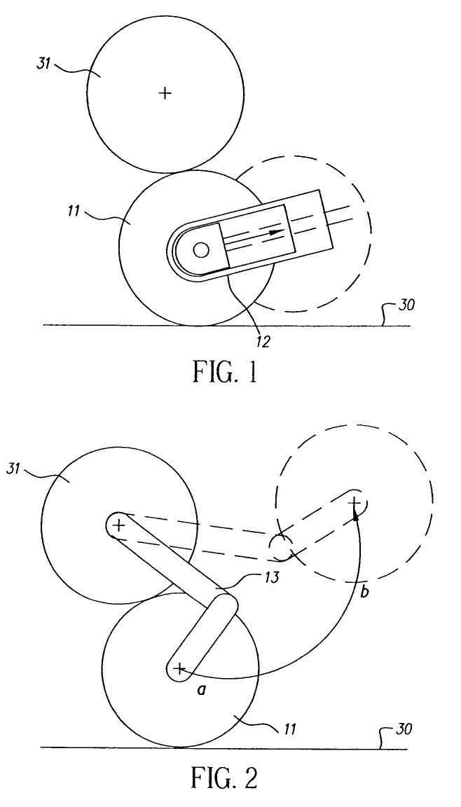

FIG. 2 shows a schematic illustration of a second embodiment of a transfer element having a variable position in accordance with the present invention. In this embodiment, the transfer element 11 is hinged to a lever system 13 and thus arranged in a pivotable manner. An imaging cylinder 31 where the image may be generated and a transport belt 30 to which the image can be transferred is shown.

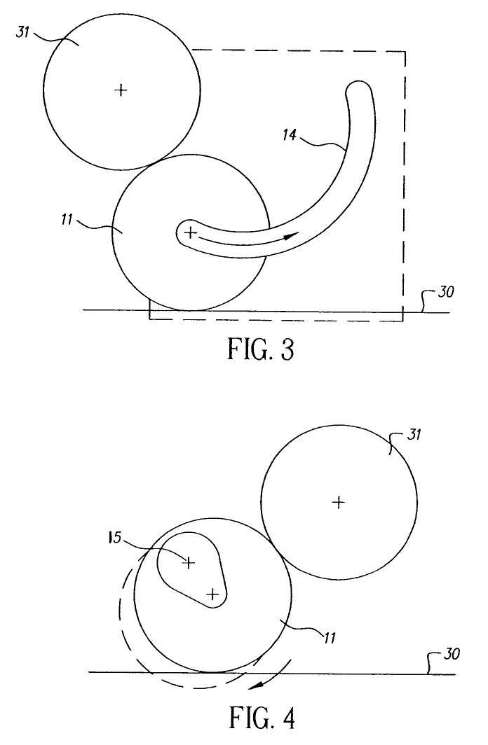

FIG. 3 shows a schematic illustration of a third embodiment of a transfer element having a variable position in accordance with the invention. In this embodiment, the transfer element 11 is supported in a guide path 14 and thus movable onto a cam and thus arranged in a manner that it can be pivoted out. An imaging cylinder 31 where the image may be generated and a transport belt 30 to which the image can be transferred is shown.

FIG. 4 shows schematic illustration of a fourth embodiment of a transfer element having a variable position in accordance with the invention. In this embodiment, the transfer element 11 is supported by an eccentric arrangement 15 and is thus arranged in such a manner that it can approach or withdraw. An imaging cylinder 31 where the image may be generated and a transport belt 30 to which the image can be transferred is shown.

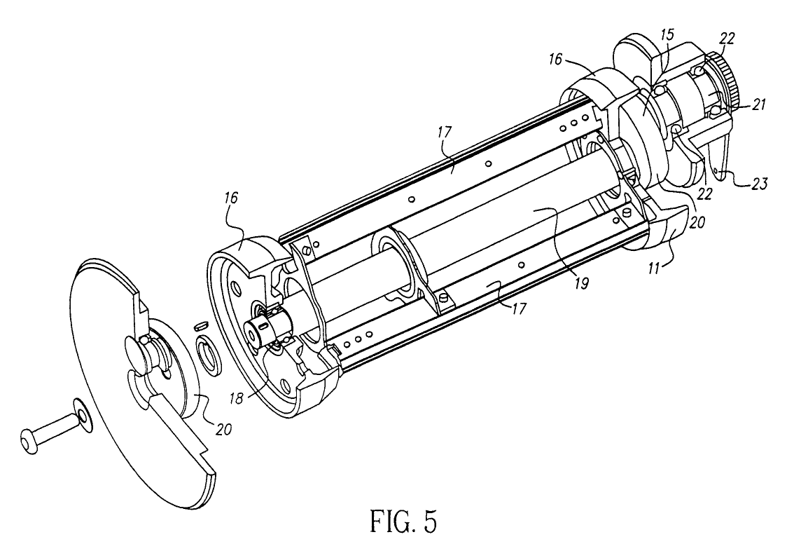

FIG. 5 shows a detailed perspective illustration of a potential embodiment of the fourth embodiment of a transfer element 11 having a variable position in accordance with the invention, as in FIG. 4, in which illustration the eccentric arrangement 15 is configured in the manner of a crankshaft.

For example, the transfer element 11 could be a rubber blanket cylinder which, in FIG. 5, is depicted only as a basic structure, on which a sleeve-like cylinder body can be arranged. At its front side, this cylinder body would be closed by flanges 16 and supported by axis-parallel struts 17. Flanges 16 can be rotated by way of roller bearings 18 and are supported on a rotational axis 19 of the transfer element 11. The ends of this rotational axis 19, in turn, are set in cams 20, so that these cams 20, together with the rotational axis 19, form a crankshaft configuration. This crankshaft configuration is continued in that, from the center of at least one of the cams 20, an outward-extending axis pin 21 is provided, which, in turn, is supported in at least one roller bearing 22. By contact with a radial lever arm 23, the cams 20 can be adjusted, as a result of which the rotational axis 19 with the cams 20 is pivoted and thus the position of the transfer element 11 is changed. As a result of this, the transfer element 11 can be brought from an operative position into an inoperative position. For example, the lever arm 23 may be contacted by a cylinder having dual functions, for example, a pneumatic cylinder.

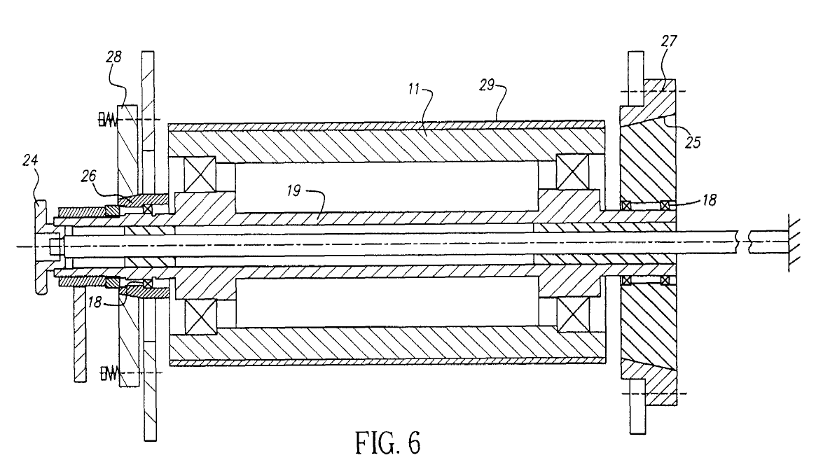

FIG. 6 shows a fifth embodiment of a transfer element 11 with rubber blanket 29 having a variable position in accordance with the invention. As in FIG. 5, the transfer element 11 is rotatably supported on a rotational axis 19 above the roller bearing 18. However, in this case, the transfer element 11 is arranged on the rotational axis 19 so that it can be shifted additionally in axial direction in order to be able to bring it into an inoperative position. To achieve this, the transfer element can be released via a means 24 at its front side and shifted to the right on the rotational axis 19 in the illustration of FIG. 6. As a result of this, cones 25 and 26 move out of engagement with flanges 27 and 28. In order to re-insert the transfer element 11 into its operative position shown by FIG. 6, the cones may be used for re-threading, guiding and centering in order to avoid damage to the transfer element 11, for example, due to jamming.

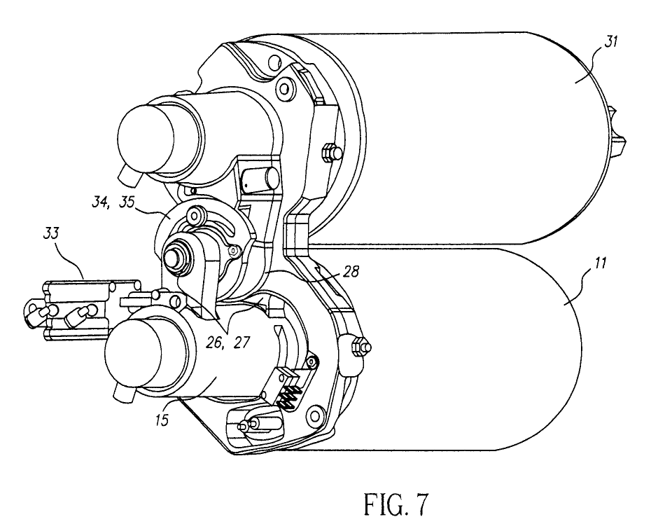

FIG. 7 shows a detailed perspective illustration of another embodiment of the fourth embodiment of a transfer element 11 having a variable position in accordance with the invention, as in FIG. 4, in which illustration the eccentric arrangement 5 is configured in the manner of a crank arm. The differences in the eccentric arrangement for FIG. 7, compared to FIG. 4, is that the crank arm 15 pivot radius is larger than the radius of the transfer element and is external to the transfer element.

For example, the transfer element 11 could be a rubber blanket cylinder. At its rear side, as shown in FIG. 7, this cylinder body is supported on its axis by bearings (not shown) that are contained within crank arm 15. Crank arm 15 can be rotated on a rotational axis formed by crank arm support points 26 and 27 (27 is hidden from view) which are set in bearings for minimal friction and positional variability. The crank arm can be rotated CW or CCW to engage or disengage the blanket element to the rubber blanket 29. The rotation can be accomplished by means of an air cylinder 33 (for example) as shown in FIG. 7. The position of support points 26 and 27 can also be varied relative to mount structure 28 to enable the nip formed between transfer element 11 and rubber blanket 29 to be adjustable. This adjustability is enabled by support points 26 and 27 being supported on a sleeve that is slightly eccentric to the axis it mounts to within mount structure 28. The sleeve 34 can be rotated by a worm gear segment 35 that is attached at the end of sleeve 34.

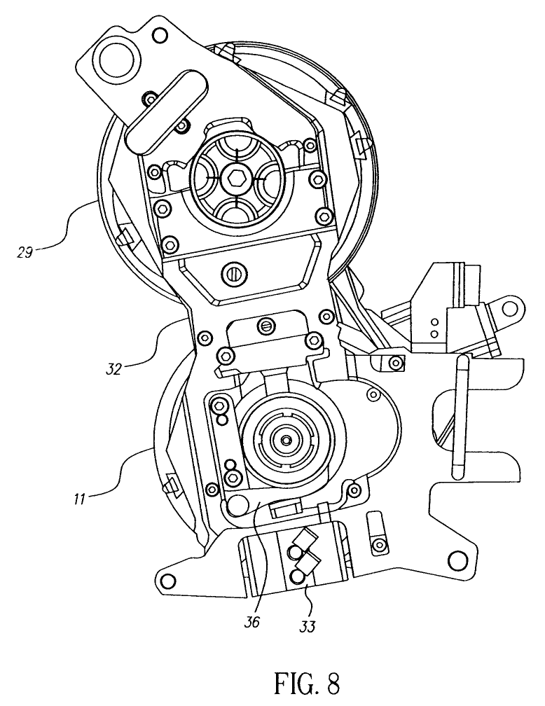

FIG. 8 shows the front side of the transfer element supported on its axis by a bearing which is clamped into support housing 32 by clamp 36 (see FIG. 8) when crank arm 15 is in the engaged position and unclamped when crank arm 15 is in the disengaged position. The clamp 36 movement could be accomplished by means of an air cylinder 33 (for example) as shown in FIG. 8.

The invention has been described in detail with particular reference to certain preferred embodiments thereof, but it will be understood that variations and modifications can be effected within the scope of the invention.

### PARTS LIST

11 transfer element
12 slide guide
13 lever system
14 guide path
15 eccentric arrangement
16 flange
17 axis-parallel struts
18 roller bearing
19 rotational axis
20 cams
21 axis pin
22 roller bearing
23 lever arm
24 means
25 cone
26 cone
27 flange
28 flange
29 rubber blanket
30 transport belt
31 imaging cylinder
32 support housing
33 air cylinder
34 sleeve
35 gear element
36 clamp

1. A printing unit for a digital multi-color printing machine comprising:
an electrophotographically sheet-printing printing machine;
wherein said printing unit comprising at least one transfer element and an imaging cylinder for the transfer of a printing image; and
wherein the transfer element can be moved from a transfer position into an inoperative position.

2. A printing unit as in claim 1 wherein the transfer element that is a rubber blanket cylinder.

3. A printing unit as in claim 2 wherein the rubber blanket cylinder can be indirectly made to rotate in contact with an imaging cylinder or a printing material transport belt or both.

4. A printing unit as in claim 1 wherein the transfer element that can be moved into and moved out of a printing material path of the printing machine.

5. A printing unit as in claim 4 wherein the transfer element can be moved away from printing material along a transport belt that transports the printing material along the printing material path.

6. A printing unit as in claim 1 wherein the transfer element guides and carries along a transfer web.

7. A printing unit as in claim 1 wherein the transfer element is pivoted in and out by means of an eccentric arrangement.

8. A printing unit as in claim 1 wherein the transfer element is moved by means of a lever system.

9. A printing unit as in claim 1 wherein the transfer element is moved by means of a sliding guide.

10. A printing unit as in claim 1 wherein the transfer element is moved along a guide path.

11. A printing unit as in claim 1 wherein the transfer element is moved out into axial direction.
